(19) United States
(12) Patent Application Publication
(10) Pub. No.: US 2016/0112602 A1
(43) Pub. Date: Apr. 21, 2016

(54) ABNORMAL NOISE OPERATION CONTROL DEVICE, IMAGE FORMING APPARATUS, ABNORMAL NOISE OPERATION CONTROL METHOD, AND NON-TRANSITORY RECORDING MEDIUM

(71) Applicant: Yoshiaki KAWAI, Kanagawa (JP)

(72) Inventor: Yoshiaki KAWAI, Kanagawa (JP)

(73) Assignee: RICOH COMPANY, LTD., Tokyo (JP)

(21) Appl. No.: 14/870,079

(22) Filed: Sep. 30, 2015

(30) Foreign Application Priority Data
Oct. 15, 2014 (JP) 2014-210962

(51) Int. Cl. H04N 1/32; H04N 1/46; H04N 1/00

(52) U.S. Cl. CPC H04N 1/32635; H04N 1/00015; H04N 1/00029; H04N 1/46; H04N 1/00082; H04N 1/00925; H04N 2201/0094; H04N 2201/0003

(57) ABSTRACT

An abnormal noise operation control device includes an abnormal noise storage device to store an abnormal noise at the time of a fault of an apparatus in advance, an operation noise acquisition device to acquire an operation noise of the apparatus, an audible sound determination device to determine whether or not the operation noise acquired is audible sound, discomfort noise determination device to determine whether or not the audible sound is a discomfort noise, a fault determination device to determine whether or not the operation noise is abnormal by comparing the operation noise with the abnormal noise, an abnormal noise cause determination device to identify a part causing the operation noise determined as at least one of the discomfort noise and the abnormal noise, and an abnormal noise countermeasures device to restrict operations that use the part and allow operations that do not use the part.

### CROSS-REFERENCE TO RELATED APPLICATIONS

This patent application is based on and claims priority pursuant to 35 U.S.C. §119 to Japanese Patent Application No. 2014-210962 on Oct. 15, 2014 in the Japan Patent Office, the entire disclosure of which is hereby incorporated by reference herein.

### BACKGROUND

1. Technical Field

The present invention relates to an abnormal noise operation control device, an image forming apparatus, an abnormal operation control method, and a non-transitory recording medium.

2. Background Art

Image forming apparatuses such as photocopiers, printers, multifunction peripherals, facsimile machines, and scanners include various drive parts of motors, actuators, etc. that make noises when they run. When such parts deteriorate or malfunction due to its long-time use, the noise made by the parts changes from the normal operation noise. In addition, it varies depending on the level of deterioration or malfunction.

Moreover, some image forming apparatus includes parts that do not normally make a noise but occasionally make noises as the parts deteriorate into an abnormal state. Furthermore, mostly image forming apparatuses are installed at a place in an office, etc. where people are present and if the operation noise is audible and becomes louder, it annoys people.

### SUMMARY

The present invention provides an improved abnormal noise operation control device which includes an abnormal noise storage device to store an abnormal noise at the time of the fault of an apparatus in advance, an operation noise acquisition device to acquire an operation noise of the apparatus, an audible sound determination device to determine whether or not the operation noise acquired is audible sound, discomfort noise determination device to determine whether or not the audible sound is a discomfort noise, a fault determination device to determine whether or not the operation noise is abnormal by comparing the operation noise with the abnormal noise, an abnormal noise cause determination device to identify a part causing the operation noise determined as at least one of the discomfort noise or the abnormal noise, and an abnormal noise countermeasures device to restrict operations that use the part and allow operations that does not use the part.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic front view of an image forming apparatus to which an embodiment of the present disclosure is applied;

FIG. 2 is a block diagram illustrating the image forming apparatus according to an embodiment of the present invention; and

FIG. 3 is an outlook perspective diagram illustrating positioning of microphones of an image forming apparatus;

FIG. 4 is a detailed block diagram illustrating an abnormal noise detection control unit;

FIGS. 5A and 5B are tables illustrating data of operation noises stored in an operation noise data memory;

FIG. 6 is a table illustrating an example of an abnormal noise data base;

FIGS. 7A and 7B are tables illustrating an example of an abnormal noise detailed data base;

FIG. 8 is a diagram illustrating the relation between audible sound and non-audible sound;

FIG. 9 is a graph illustrating the relation between the frequency of breakdown (fault) and the number of prints, the number of jobs, and the number of switching on and off of a power supply;

FIG. 10 is a graph illustrating the relation between part groups of an image forming apparatus, operation timing, and sound pressure level;

FIGS. 11A and 11B are a flow chart illustrating abnormal noise operation control processing; and

FIG. 12 is a diagram illustrating the relation between abnormal noise and ambient noise.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Preferred embodiments of the present invention are described in detail below with reference to the accompanying drawings. Although the presently preferred embodiments of the present invention are described with various technically preferred limitations, the scope of the invention should not be construed as limited by the embodiments discussed below. It should not be construed that all of elements of the embodiments discussed below are essential to the invention unless specifically stated as such.

### Embodiment 1

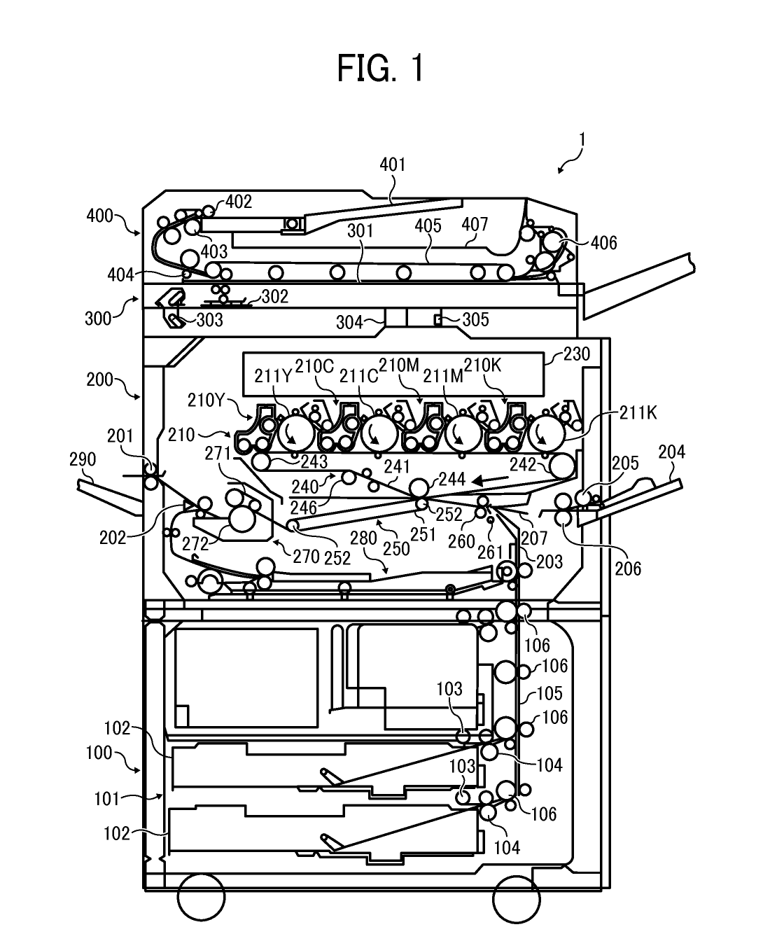

FIGS. 1 to 12 are diagrams illustrating an embodiment 1 of the abnormal noise operation control device, the image forming apparatus, the abnormal noise operation control method, and a non-transitory program of the present disclosure. FIG. 1 is a schematic front view of an image forming apparatus 1 to which an embodiment of the image forming apparatus, the abnormal noise operation control method, and a non-transitory program of the present disclosure is applied.

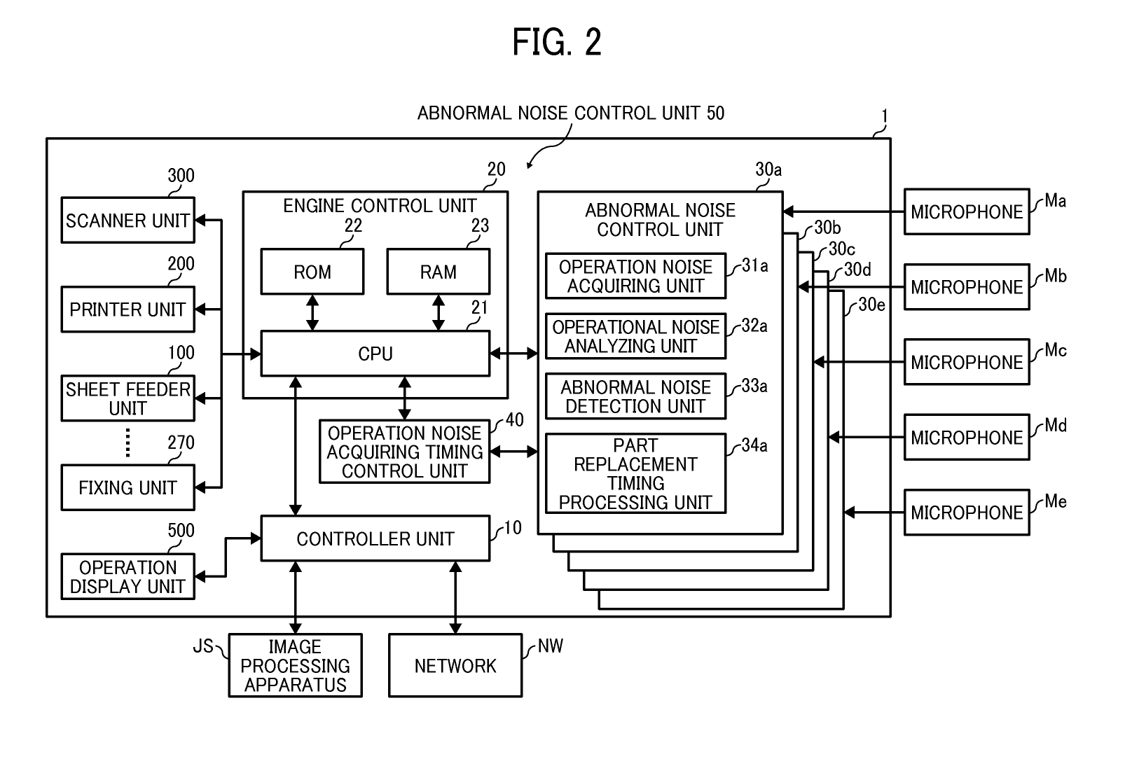

In FIG. 1, the image forming apparatus 1 is an image processing device to execute image processing such as a printer, a facsimile machine, a photocopier, a multifunction peripheral, or a scanner. The image forming apparatus 1 executes various image processing operations such as image forming processing, scanner processing, facsimile processing, image kind changing processing, image data transfer processing, and image data accumulating processing in response to, for example, image processing requests from an information processing apparatus JS (refer to FIG. 2) such as computer. In addition, the image forming apparatus 1 itself executes photocopying processing by reading an image of a document and recording and outputting the image on a recording medium. The image forming apparatus corresponds to the apparatus in the present disclosure.

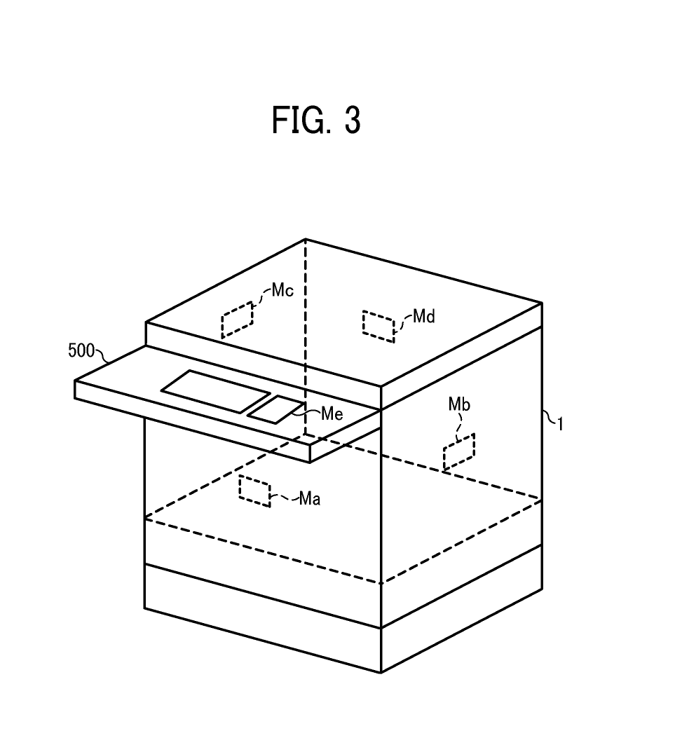

The image forming apparatus 1 has a laminated installation that sequentially includes a sheet feeding unit (sheet feeder) 100, a printer unit 200, and a scan unit (scanner) 300 in this order. An automatic document feeder (hereinafter referred to as ADF) 400 is provided on the scan unit 300. In addition, the image forming apparatus 1 includes an operation display unit (display) 500 (refer to FIG. 2 and FIG. 3).

The printer unit 200 includes an image forming unit 210 having four sets of a process cartridge 210Y, a process cartridge 210C, a process cartridge 210M, and a process cartridge 210K to respectively form each color image of yellow (Y), magenta (M), cyan (C), and black (K), an optical writing unit 230, an intermediate transfer unit 240, a secondary transfer unit 250, a pair of registration rollers 260, a fixing unit 270 using a belt fixing method, and a sheet reversing unit 280.

The optical writing unit 230 includes a light source, a polygon mirror, fθ lens, and a reflection mirror. The optical writing unit 230 respectively irradiates the surface of a photoconductor 211Y, a photoconductor 211C, a photoconductor 211M, and a photoconductor 211K of each color of the process cartridge 210Y, the process cartridge 210C, the process cartridge 210M, and the process cartridge 210K with laser beams modulated based on each color image data to form a latent electrostatic image for each color on the photoconductor 211Y, the photoconductor 211C, the photoconductor 211M, and the photoconductor 211K. An IC tag is provided to each of the process cartridge 210Y, the process cartridge 210C, the process cartridge 210M, and the process cartridge 210K, which are detachably attachable to the image forming apparatus 1.

The process cartridge 210Y, the process cartridge 210C, the process cartridge 210M, and the process cartridge 210K include chargers, developing devices, cleaning units, and dischargers around the photoconductor 211Y, the photoconductor 211C, the photoconductor 211M, and the photoconductor 211K having a drum-like form. In the process cartridge 210Y, the process cartridge 210C, the process cartridge 210M, and the process cartridge 210K, the chargers uniformly charge the surface of the photoconductor 211Y, the photoconductor 211C, the photoconductor 211M, and the photoconductor 211K by slidably abrading charging rollers to which an alternative voltage is applied with the photoconductor 211Y, the photoconductor 211C, the photoconductor 211M, and the photoconductor 211K.

In the process cartridge 210Y, the process cartridge 210C, the process cartridge 210M, and the process cartridge 210K, the optical writing unit 230 irradiates the charged surface of each of the photoconductor 211Y, the photoconductor 211C, the photoconductor 211M, and the photoconductor 211K with modulated or polarized laser beams based on each color image data. In the process cartridge 210Y, the process cartridge 210C, the process cartridge 210M, and the process cartridge 210K, latent electrostatic images for each color are formed on the drum surface of the photoconductor 211Y, the photoconductor 211C, the photoconductor 211M, and the photoconductor 211K.

Thereafter, each color toner is supplied to the surface of the photoconductor 211Y, the photoconductor 211C, the photoconductor 211M, and the photoconductor 211K from the developing devices to develop the latent electrostatic images to form toner images for each color. The toner images formed on the surface of the photoconductor 211Y, the photoconductor 211C, the photoconductor 211M, and the photoconductor 211K are intermediately transferred to an intermediate transfer belt 241, which is described later. The residual toner remaining on the surface of the photoconductor 211Y, the photoconductor 211C, the photoconductor 211M, and the photoconductor 211K are removed by the cleaning unit after the intermediate transfer.

Thereafter, the photoconductor 211Y, the photoconductor 211C, the photoconductor 211M, and the photoconductor 211K are caused to furthermore rotate followed by discharging by the discharges The photoconductor 211Y, the photoconductor 211C, the photoconductor 211M, and the photoconductor 211K are thereafter uniformly charged again to return to the initial state and be ready for the next image forming.

The intermediate transfer unit 240 includes the intermediate transfer belt 241, a first support roller 242, a second support roller 243, a third support roller 244, and an intermediate transfer belt cleaning unit (cleaner) 245. The intermediate transfer belt 241 is stretched over the first support roller 242, the second support roller 243, and the third support roller 244. The intermediate transfer unit 240 includes four intermediate transfer bias rollers arranged facing the photoconductor 211Y, the photoconductor 211C, the photoconductor 211M, and the photoconductor 211K with the intermediate transfer belt 241 therebetween. At least one of the first support roller 242, the second support roller 243, and the third support roller 244 is rotationally driven, thereby to rotationally drive and rotate the intermediate transfer belt 241 clockwise indicated by the arrow in FIG. 1. The photoconductor 211Y, the photoconductor 211C, the photoconductor 211M, and the photoconductor 211K of the process cartridge 210Y, the process cartridge 210C, the process cartridge 210M are arranged side by side along the portion of the intermediate transfer belt 241 between the first support roller 242 and the second support roller 243. After the image transfer, an intermediate transfer belt cleaning unit 245 removes residual toner remaining on the intermediate transfer belt 241 on the downstream of the third support roller 244 from the rotation direction of the intermediate transfer belt 241.

For example, the intermediate transfer belt 241 is a multi-layered belt having an elastic layer on a substrate layer formed of a fluoro resin having less extensibility, a rubber material having a large extensibility, and a non-extensible material such as canvas.

The elastic layer is formed by applying a coat layer coated with a fluoro resin to achieve good smoothness to the surface of fluoro rubber or a copolymer rubber of acrylonitrile-butadiene.

Below the intermediate transfer unit 240 is arranged a secondary transfer unit 250, in which a secondary transfer belt 251 having an endless form is stretched over two stretching rollers 252. The secondary transfer belt 251 is rotationally moved counterclockwise in FIG. 1 by the rotation of at least one of the stretching rollers 252. Of the two stretching rollers 252, the stretching roller 252 arranged on the right hand side in FIG. 1 sandwiches the intermediate transfer belt 241 and the secondary transfer belt 251 with the third support roller 244 of the intermediate transfer unit 240 and pushes up the intermediate transfer belt 241 against the third support roller 244 to form a secondary transfer nip.

A secondary transfer bias having a reverse polarity to the toner is applied to the stretching roller 252 located on the side of the third support roller 244 by a power supply. By this application of the secondary transfer bias, a secondary transfer electric field is formed to electrostatically move the color toner image on the intermediate transfer belt 241 from the intermediate transfer belt 241 toward the stretching roller 252 on the third support roller 244.

The pair of registration rollers 260 feeds a recording medium to the secondary transfer nip in synchronization with a color toner image on the intermediate transfer belt 241. The color toner image is secondarily transferred from the intermediate transfer belt 241 to the recording medium fed into the secondary transfer nip by a secondary transfer electric field or the nip pressure.

The pair of intermediate transfer registration rollers 241 is arranged on the upstream of the secondary transfer nip from the moving direction of the intermediate transfer belt 241. The recording medium is fed between the pair of the registration rollers 260 from the sheet feeding unit 100 (which is described later) into the printer unit 200. A registration sensor 261 is arranged on the upstream of the pair of the registration rollers 260 from the transfer direction of the recording medium to detect the recording medium fed to the pair of the registration rollers 260.

In the intermediate transfer unit 240, the color toner image formed on the intermediate transfer belt 241 enters into the secondary transfer nip according to the rotation conveyance of the intermediate transfer belt 241. The pair of the registration rollers 260 nips the recording medium (sheet) between the rollers based on the detection result of the registration sensor 261 and sends out the recording medium nipped between the rollers at a timing adjusted to attach the color toner image at the secondary transfer nip. The color toner image on the intermediate transfer belt 241 is attached to and secondarily transferred to the recording medium sent at the adjusted timing to form a full color image on the white background of the recording medium.

The pair of registration rollers 260 is typically grounded but a bias can be applied thereto to remove paper dust on the recording medium. For example, a bias is applied to the pair of registration rollers 260 when the rollers are made of electroconductive rubber. The pair of the registration rollers 260 normally has a diameter of 18 mm, a surface having a thickness of 1 mm made of electroconductive NBR rubber, and an electric volume resistance of about 10⁹ Ωcm of rubber material. When a bias is applied to the pair of the registration rollers, the surface of the recording medium is slightly negatively charged after the recording medium has passed the registration rollers. Therefore, as for the transfer of the image from the intermediate transfer belt 241 to the recording medium, the transfer conditions are changed in some cases because the conditions are different from those in the case in which no bias is applied to the pair of the registration rollers 260. In general, in the image forming apparatus 1, about −800 V is applied to the side (top side) of the intermediate transfer belt 241 onto which the toner is transferred and about +200 V is applied to the side (rear side) of the recording medium by the transfer rollers for the photoconductors 211Y, 211C, 211M, and 211K.

The recording medium on which the full color is thus-formed is sent out of the secondary transfer nip according to the rotation conveyance of the secondary transfer belt 251 and thereafter conveyed from the second transfer belt 251 to the fixing unit 270.

The fixing unit 270 includes a fixing belt 271 that rotationarily moves while being heated and a pressing roller 272 pressed against the fixing belt 271. The fixing belt 271 heats the recording medium received from the secondary transfer belt 251 to a particular fixing temperature and transfers the recording medium while pressing the medium with the pressing roller 272.

The feeding unit 100 stores multi-stuck sheet feeding cassettes 102 in a paper bank 101. The cassettes 102 are capable of storing different kinds of sheets and different sizes of sheets. Each sheet feeding cassette 102 includes a sheet feeding roller 103 to feed the recording medium (sheet) in the sheet feeding cassette 102 and a separation roller 104 to separate and feed the recording media (sheets) fed out of the separation roller 103 one by one. The sheet feeding unit 100 includes a sheet path 105 and a transfer roller 106 to feed the sheet fed from each cassette 102 to the printer unit 200. The sheet feeding unit 100 starts the sheet feeding operation almost at the same time of starting reading a document and selectively rotates one of the sheet feeding rollers 103 to feed a recording medium from one of the multi-stuck sheet feeding cassettes 102 located in the paper bank 101. After the sheet feeding unit 100 separates the recording medium one by one by the separation roller 104 and feeds it into the sheet path 105, the transfer roller 106 feeds the recording medium into a sheet path 203 in the printer unit 200. The sheet feeding cassette 102 includes a sheet end sensor to detect the remaining amount of the recording media and whether or not the remaining amount is empty, a size detection sensor to detect the size and the direction of the recording medium and a tray set detection sensor to detect whether each cassette 102 is mounted onto the sheet feeding unit 100 of the image forming apparatus 1.

In addition, the image forming apparatus 1 includes a bypass tray 204 on the side of the printer unit 200. Also, a sheet feeding roller 205 and a separation roller 206 to separate and feed the recording media on the bypass tray 204 one by one are provided.

The image forming apparatus 1 rotates the sheet feeding roller 205 to feed the recording media on the bypass tray 204 when the bypass tray 204 is selected. Also, the recording media are separated by the separation roller 206 one by one and fed into a bypass sheet path 207 of the printer unit 200.

The image forming apparatus 1 transfers the recording medium fed to the sheet path 203 in the printer unit 200 or the bypass sheet path 207 and secondarily transfer the color toner image via the pair of the registration rollers 206 and the secondary transfer nip. The image forming apparatus 1 fixes the toner image on the recording medium at the fixing unit 270 and thereafter discharges the medium outside the image forming apparatus 1.

A path sensor is provided in the image forming apparatus 1 to detect whether or not there is a recording medium on the sheet path of the recording medium having the toner image thereon transferred by the secondary transfer nip to transfer the recording medium and control operations of the unit where the recording medium is transferred.

The recording medium that has passed through the fixing unit 270 is discharged outside the apparatus via a pair of the discharging roller 201 and stacked at a stack 290 or conveyed to the sheet reversing unit 280 situated below the fixing unit 270.

The sheet reversing unit 280 reverses the recording medium conveyed upside down and thereafter sends it by way of the pair of the registration rollers 260 to the secondary transfer nip where the intermediate transfer belt 241 of the intermediate transfer unit 240 contacts the secondary transfer belt 251 of the secondary transfer unit 250. The sheet reversing unit 280 secondarily transfers a color toner image on the other side of the recording medium at the secondary transfer nip. Thereafter, the recording medium is discharged outside via the fixing unit 270. Whether the recording medium is conveyed from the fixing unit 270 to the pair of the discharging roller 201 or the sheet reversing unit 280 is conducted by switching the sheet paths by a switching claw 202.

The scan unit 300 includes a pressure glass 301, a first scanning member 302 that carries a light source and a first mirror, a second scanning member 303 that carries a second mirror and a third mirror, an imaging forming lens 304, a reading sensor 305, etc. The first scanning member 302 and the second scanning member 303 are housed in the housing of the image forming apparatus 1 situated below the pressure glass 301 and disposed movable in the sub-scanning direction (horizontal direction in FIG. 1). The scan unit 300 irradiates a document set on the pressure glass 301 with reading light from the light source on the first scanning member 302 while the first scanning member 302 and the second scanning member 303 are moving in the sub-scanning direction. The reflection light of the reading light from the document is reflected at the first mirror on the first scanning member 302 to the second mirror on the second scanning member 303. The incident light to the second mirror is reflected to the third mirror of the second scanning member 303, where the incident light to the third mirror is reflected to the imaging forming lens 304. The imaging forming lens 304 collects the incident light to the reading sensor 305. The reading sensor 305 conducts photoelectric conversion of the incident light to read the image of the document.

The ADF 400 includes a platen 401, a sheet feeding roller 402, a separation roller 403, a transfer roller 404, and a transfer belt 405, a discharging roller 406, a discharging base 407, etc. and attached to the housing of the image forming apparatus 1 with the pressure glass 301 openable.

When the upper surface of the pressure glass is open, a document like a book can be set on the pressure glass 301. In addition, when the ADF 400 is shut while a document is set on the pressure glass 301, the ADF 400 serves as a pressing plate to press the document against the pressure glass 301.

A sheet-like document is set on the platen 401 when the ADF 400 is closed. When the start key is pressed on the operation display unit 500 (refer to FIG. 2) and to start reading is instructed, the document on the platen 401 is sent out by the sheet feeding roller 402 and the document is separated and transferred by the separation roller 403 one by one. The transfer roller 404 transfers the sent-out document one by one to the transfer belt 405. The transfer belt 405 transfers the transferred document to the reading position on the pressure glass 301.

When the scan unit 300 completes reading the document on the reading position on the pressure glass 301, the document that has been read is transferred to the discharging roller 406 by the transfer belt 405. The discharging roller 406 discharges the recording medium onto the discharging base 407.

As illustrated in FIG. 2, the image forming apparatus 1 includes a control unit (controller) 10, an engine control unit 20, abnormal noise detection control units 30a to 30e, and an operation noise acquiring timing control unit 40. In addition, in FIG. 2, the image forming apparatus 1 further includes the scan unit 300, the printer unit 200, the sheet feeding unit 100, the fixing unit 270, and the operation display unit 500.

Moreover, as illustrated in FIG. 3, the image forming apparatus 1 includes microphones Ma to Md arranged near the four inside walls of the housing and a microphone Me positioned near the operation display unit 500. The microphones Ma to Md collect the operation noise in the housing of the image forming apparatus 1 and output the analog operation noise to the abnormal noise detection control units 30a to 30d. The microphones Ma to Md collect the ambient noise outside the image forming apparatus 1 and output the analog ambient noise to the abnormal noise detection control unit 30e. The microphone Me collects mainly the operation noise outside the image forming apparatus 1 and the ambient noise outside the image forming apparatus 1 and outputs the analog operation noise and ambient noise to the abnormal noise detection control unit 30e. Therefore, the microphones Ma to Me function as the operation noise acquisition devices and also the ambient noise acquisition devices.

The control unit 10 of the image forming apparatus 1 is connected with an information processing apparatus JS or network NW such as Local Area Network (LAN) and sends and receives image data or information with the information processing apparatus JS or other information processing devices and image forming apparatuses connected to the network NW.

The operation display unit 500 includes various operation keys and a display (liquid crystal display, etc.). For example, a display with touch screen in which touch sensitive panels are laminated on a liquid panel) is used as the display. The operation display unit 500 outputs an operation instruction of operation keys and outputs and displays display data from the control unit 10 on the display.

The control unit 10 includes, a read only memory (ROM), a central processing unit (CPU), a random access memory (RAM), etc. The control unit 10 stores basic programs and required system data for the image forming apparatus 1 in the ROM. The CPU controls each unit of the image forming apparatus 1 while utilizing the RAM as a work memory based on the program in the ROM to execute the basic processing as the image forming apparatus 1. Also, the CPU executes the abnormal noise operation control processing coupled with the engine control unit 20.

The control unit 10 is connected with a service center for repair and maintenance of the image forming apparatus 1 via the network NW and provides the center with information and repair notifications based on the detection results of the abnormal noise control units 30a to 30e described later.

The engine control unit 20 includes a CPU 21, a ROM 22, and RAM 23. The ROM 22 stores the engine control program, the abnormal noise operation control program, and required system data.

The CPU 21 is connected with each unit of the scan unit 300, the printer unit 200, the sheet feeding unit 100, the fixing unit 270, and the operation display unit 500, and the abnormal noise detection control units 30a to 30e as well as the control unit 10.

The CPU 21 controls the image processing systems such as the scan unit 300, the printer unit 200, the sheet feeding unit 100, and the fixing unit 270 based on the program in the ROM 22 and the instructions from the control unit 10 and executes various image processing operations of the image forming apparatus 1. In addition, the engine controller executes restriction control of operation relating to abnormal noises and normal operation control of operations not relating to the abnormal noises of various operations of the image forming apparatus 1 under the control of the control unit 10 based on the abnormal noise detection results of the abnormal noise detection controllers 30a to 30e.

The abnormal noise detection controllers 30a to 30e includes operation noise acquiring units 31a to 31e, operation noise analyzing units (analyzers) 32a to 32e, abnormal noise detection units (detectors) 33a to 33e, and part replacement timing processing units (processors) 34a to 34e.

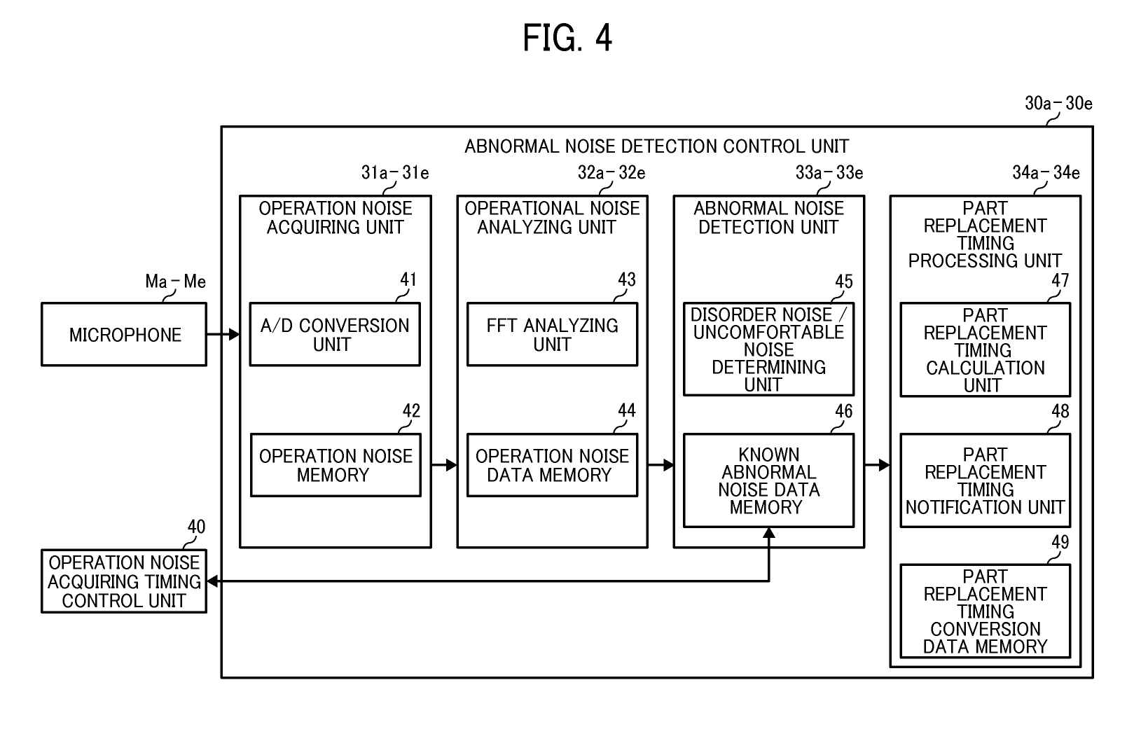

The operation noise acquiring units 31a to 31d receive the operation noise and ambient noise of the image forming apparatus 1 collected by the microphones Ma to Md from corresponding microphones Ma to Md, convert them into digital data, and output them to corresponding operation noise analyzing units 32a to 32d. The operation noise acquiring unit 31e receives the operation noise and ambient noise outside the image forming apparatus 1 collected by the microphone Me from the microphones Me, converts them into digital data, and outputs them to corresponding operation noise analyzing unit 32e. To be more specific, as illustrated in FIG. 4, the operation noise acquiring units 31a to 31e include an analog/digital (A/D) conversion unit (converter) 41 and an operation noise memory 42.

The A/D conversion unit 41 converts analog operation noise and ambient noise input from the microphones Ma to Me into digital data and outputs them into the operation noise analyzing unit 32 and the operation noise memory 42.

The operation noise memory 42 uses non-volatile memory such as Nonvolatile Random Access Memory (NVRAM) and stores the digital data of the operation noise and the ambient noise for each collected noise through the microphones Ma to Me.

The operation noise analyzing units 32a to 32e include fast Fourier transformation (FFT) analyzing unit (analyzer) 43 and an operation noise data memory 44 and analyzes the frequency and sound pressure of the operation noise and the ambient noise acquired by the operation noise acquiring unit 31.

The FFT analyzing unit 43 executes Fourier transformation of the noise operation and the ambient noise input from the operation noise acquiring unit 31 and classifies them according to the preset frequencies followed by sampling for each frequency to acquire the sound pressure level for each frequency.

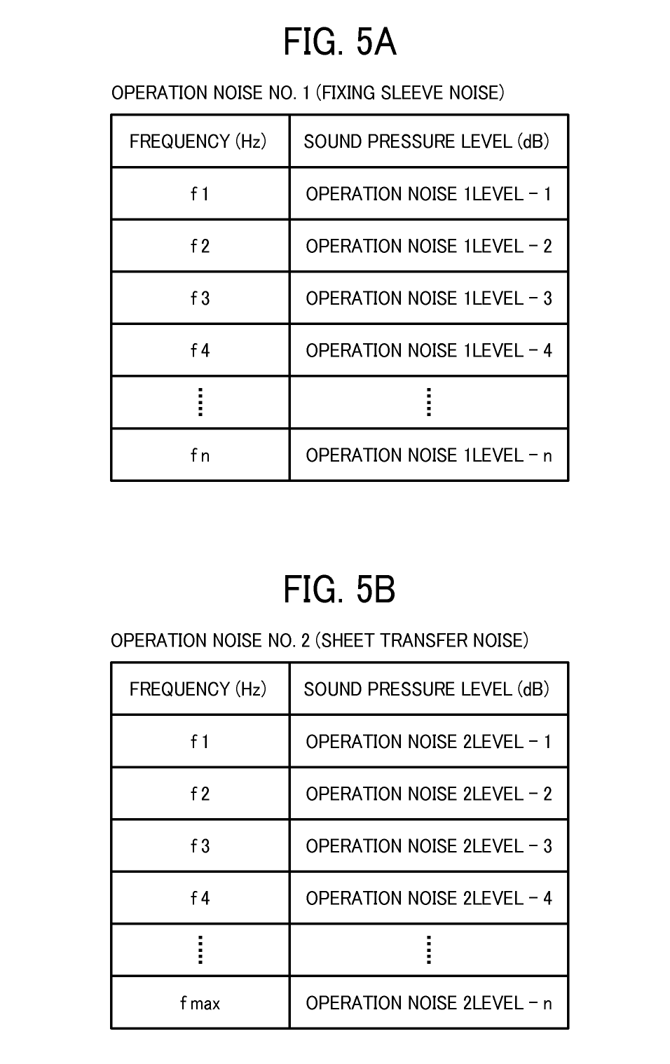

The operation noise data memory 44 is configured by a non-volatile memory such as Nonvolatile Random Access Memory (NVRAM) and stores the sound pressure level for each frequency of the operation noise acquired by the FFT analyzing unit 43, for example, as illustrated in FIG. 5.

In FIG. 5A, the sound pressure level (dB) of the fixing sleeve noise (operation noise during fixing sleeve operation) is stored for each frequency (f1 to fn) as the operation noise No. 1. In FIG. 5B, the sound pressure level (dB) of the sheet transfer (conveyance) noise (operation noise during sheet transfer) is stored for each frequency (f1 to fmax) as the operation noise No. 2.

The operation noise data memory 44 has a memory capacity to store operation noise data for multiple operation noises. When the operation noise data are stored to the limit of the memory capacity, the data are sequentially replaced with new data from the oldest data.

The operation noise analyzing units 32a to 32e determine whether or not the acquired operation noise is audible. These analyzing units serve as an audible noise determination device.

The abnormal noise detection units (detectors) 33a to 33e have a breakdown noise/discomfort noise determining unit 45 and a known abnormal noise data memory 46 to detect whether or not the sound pressure level for each frequency analyzed and acquired by the operation noise analyzer 32a to 32e is an abnormal noise.

The known abnormal noise data memory 46 is configured by NVRAM etc. to store abnormal noises of each part of the image forming apparatus 1 in advance. Therefore, the known abnormal noise data memory 46 serves as an abnormal noise storage device.

The breakdown noise/discomfort noise determining unit 45 compares the sound pressure level for each frequency analyzed and acquired by the operation noise analyzers 32a to 32e with the abnormal noise in the known abnormal noise data memory 46 to determine whether or not an operation noise is a normal noise, a discomfort noise, or an abnormal noise (breakdown noise).

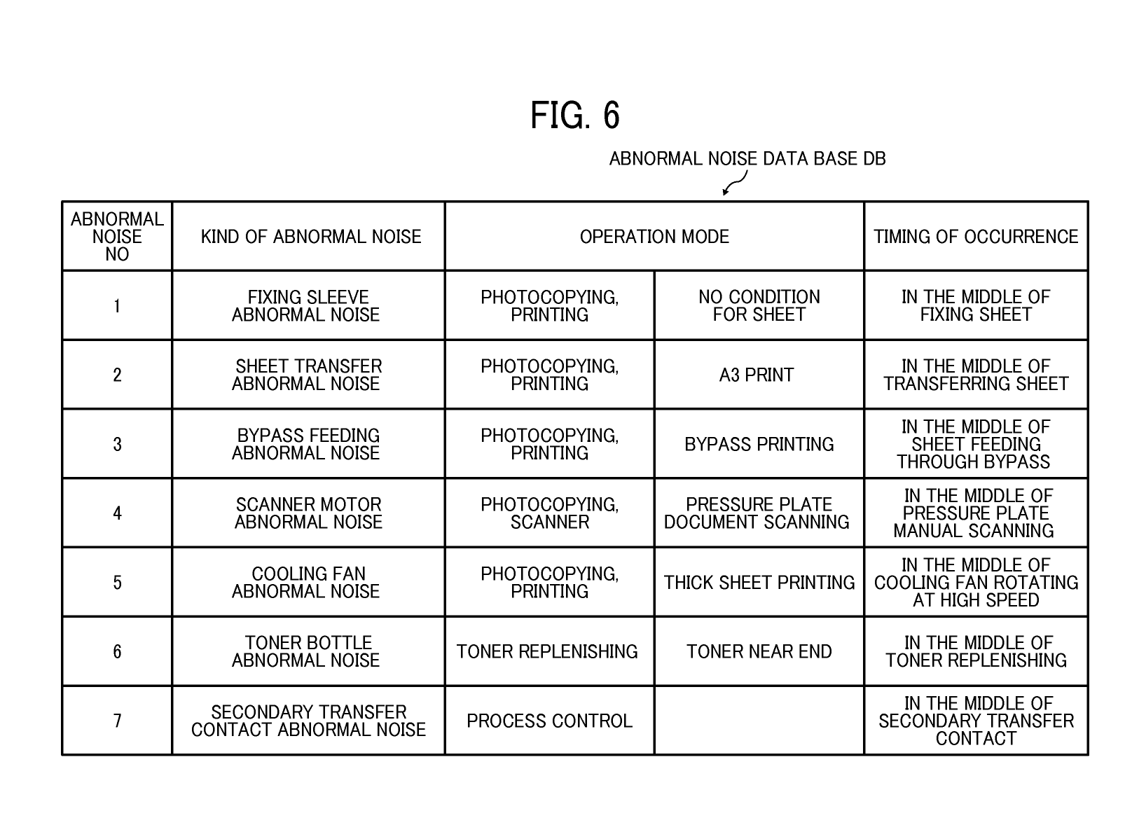

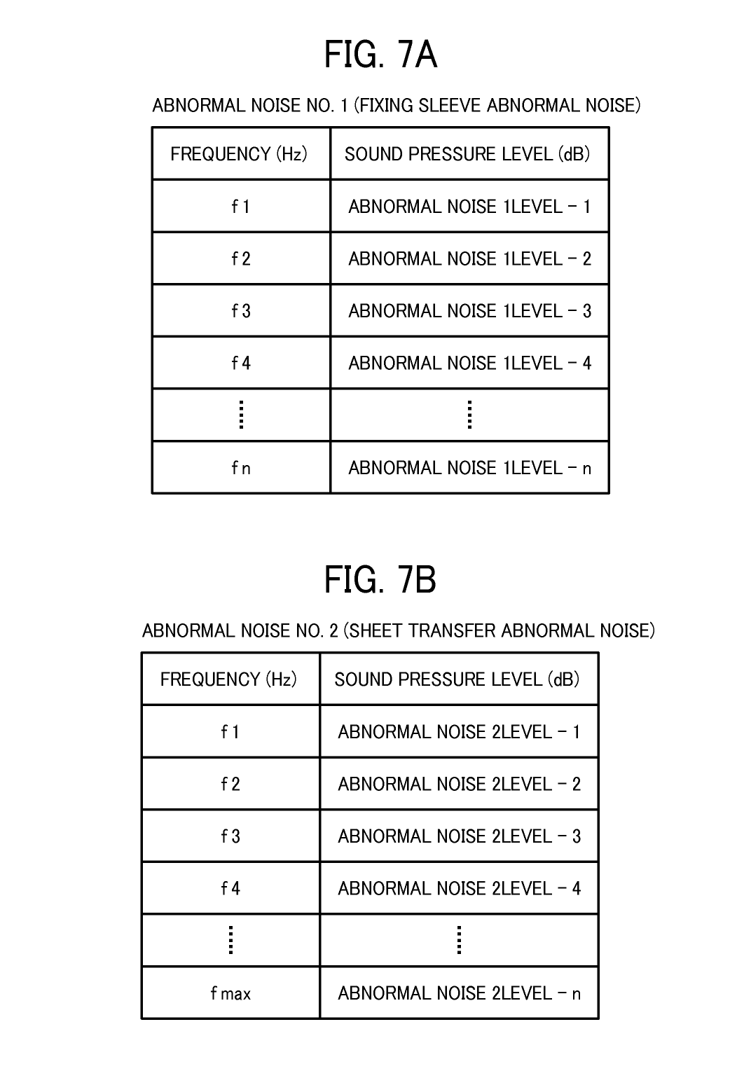

This known abnormal noise data memory 46 stores, for example, known abnormal noises of each part as illustrated in FIG. 6 and FIG. 7. That is, FIG. 6 is a table of an example of abnormal noise data base. The abnormal noise data base DB stores registered information of kinds (articles) of abnormal noises, operation modes in which the abnormal noises occurred, and timing of occurrence of abnormal noises for each abnormal noise No. For example, for the abnormal noise No. 1 in the case of FIG. 6, fixing sleeve abnormal noise as the article of abnormal noise, photocopying, printing, and no condition for recording medium as operation mode, and in the middle of fixing sheet as timing of occurrence are registered. That is, the abnormal noise are different when operation modes and conditions are different and occur only at operations described in the abnormal noise database DB.

For example, the sound pressure level of an abnormal noise is registered for each frequency for the fixing sleeve abnormal noise of the abnormal noise No. 1, as illustrated in FIG. 7A, and another sound pressure level of abnormal noise for each frequency is registered for the sheet transfer abnormal noise of the abnormal noise No. 2, as illustrated in FIG. 7B. FIG. 7 includes only the abnormal noise No. 1 and the abnormal noise No. 2. However, for example, the sound pressure levels for all the seven abnormal noises illustrated in FIG. 6 are registered in the known abnormal noise data memory 46 in advance.

When an operation noise is determined as an abnormal noise, the breakdown noise/discomfort noise determining unit 45 determines whether the abnormal noise is an audible discomfort noise or an audible breakdown noise.

That is, the breakdown noise/discomfort noise determining unit 45 compares the sound pressure level for each frequency analyzed and acquired by the operation noise analyzing units 32a to 32e with the sound pressure level (reference value) of the abnormal noise as illustrated in FIG. 6 and FIG. 7 to determine whether or not an operation noise has a sign leading to the occurrence of an abnormal noise. Specifically, the breakdown noise/discomfort noise determining unit 45 determines an operation noise as an operation noise with a sign leading to the occurrence of an abnormal noise if the sound pressure level of the operation noise surpasses that of the abnormal noise and as a normal noise if the sound pressure level of the operation noise is below that of the abnormal noise. Different values are set for the sound pressure level determined as an abnormal noise at the abnormal noise detection control units 30a to 30e since the microphones Ma and Me are positioned at different places.

When the sound pressure level of an operation noise surpasses that of the abnormal noise for a frequency, the breakdown noise/discomfort noise determining unit 45 outputs the frequency and the sound pressure level to the part replacement timing processing unit 34. That is, the breakdown noise/discomfort noise determining unit 45 determines whether or not the operation noise is abnormal and identifies the part causing the operation noise determined as abnormal.

In addition, the breakdown noise/discomfort noise determining unit 45 determines whether or not the abnormal noise is audible and provides a notification to the part replacement timing processing unit 34.

Therefore, the abnormal noise detectors 33a to 33e determine whether or not the audible noise is uncomfortable, meaning that it serves as a discomfort noise determination device. In addition, the abnormal noise detectors 33a to 33e compare the acquired operation noise with the abnormal noise to determine whether or not the operation noise is abnormal, meaning that it serves as an abnormal noise determination device. Furthermore, the abnormal noise detectors 33a to 33e also identify the part causing an operation noise determined as at least one of the discomfort noise and the abnormal noise, meaning that it serves as an abnormal noise cause identifying device.

The part replacement timing processor 34 (remaining life expectancy predictor) includes a part replacement timing calculation unit (calculator) 47, a part replacement timing notification unit 48, and a part replacement timing conversion data memory 49 as illustrated in FIG. 4 and determines the replacement timing of a part and provides a notification based on the operation noise determined as abnormal by the abnormal noise detectors 33a to 33e and the part causing the noise.

The part replacement timing calculation unit 47 calculates the replacement timing of the part having a sign leading to occurrence of trouble identified by the abnormal noise detectors 33a to 33e and accumulates the data for replacement timing in the part replacement timing conversion data memory 49.

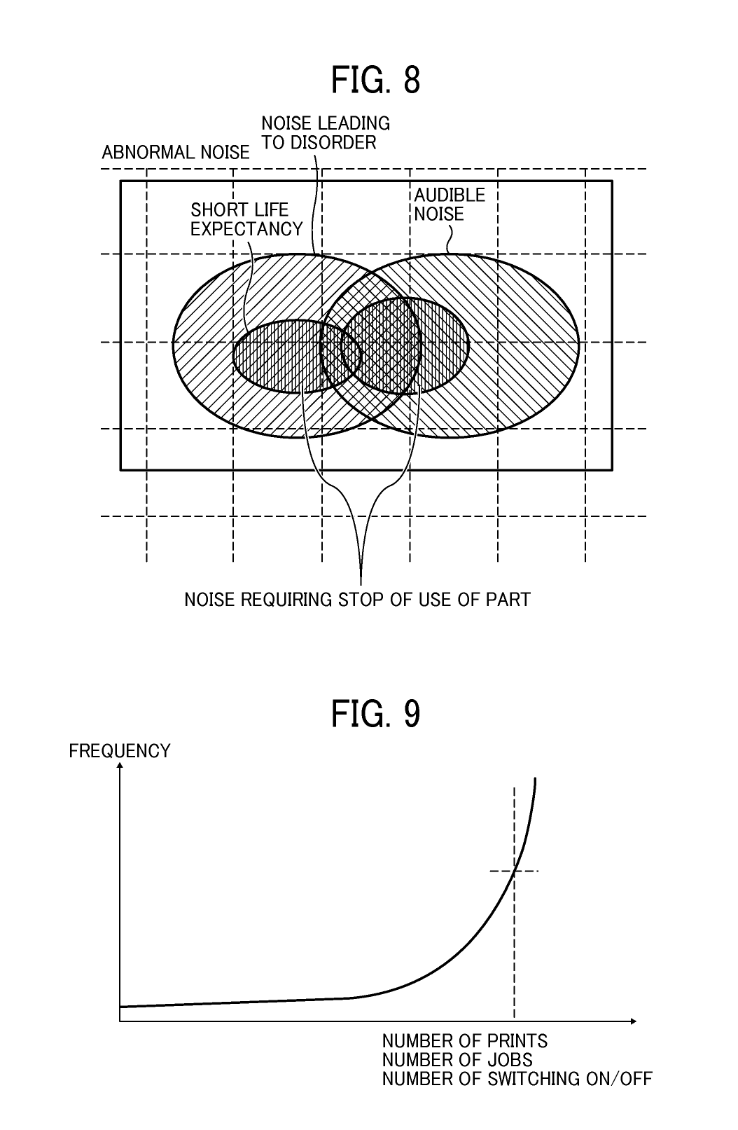

In addition, the part replacement timing calculation unit 47 calculates the replacement timing based on whether the operation noise is audible. That is, when the sound pressure level is or surpasses an abnormal noise, the part replacement timing calculation unit 47 determines whether or not the abnormal noise is within the audible range (noise audible to the human ear, which is from about 20 Hz to about 15,000 Hz) as illustrated in FIG. 8. When the abnormal noise is audible, users feel it as uncomfortable. When the abnormal noise is inaudible, users do not perceive it as a discomfort noise so that the part can still be used unless it leads to immediate breakdown. For example, when the abnormal noise is audible, the part replacement timing calculation unit 47 calculates the part replacement timing shorter to augment comfort for users when they use the image forming apparatus 1.

The part replacement timing conversion data memory 49 is configured by NVRAM, etc. and stores the replacement timing calculated by the part replacement timing calculation unit 47 for each part.

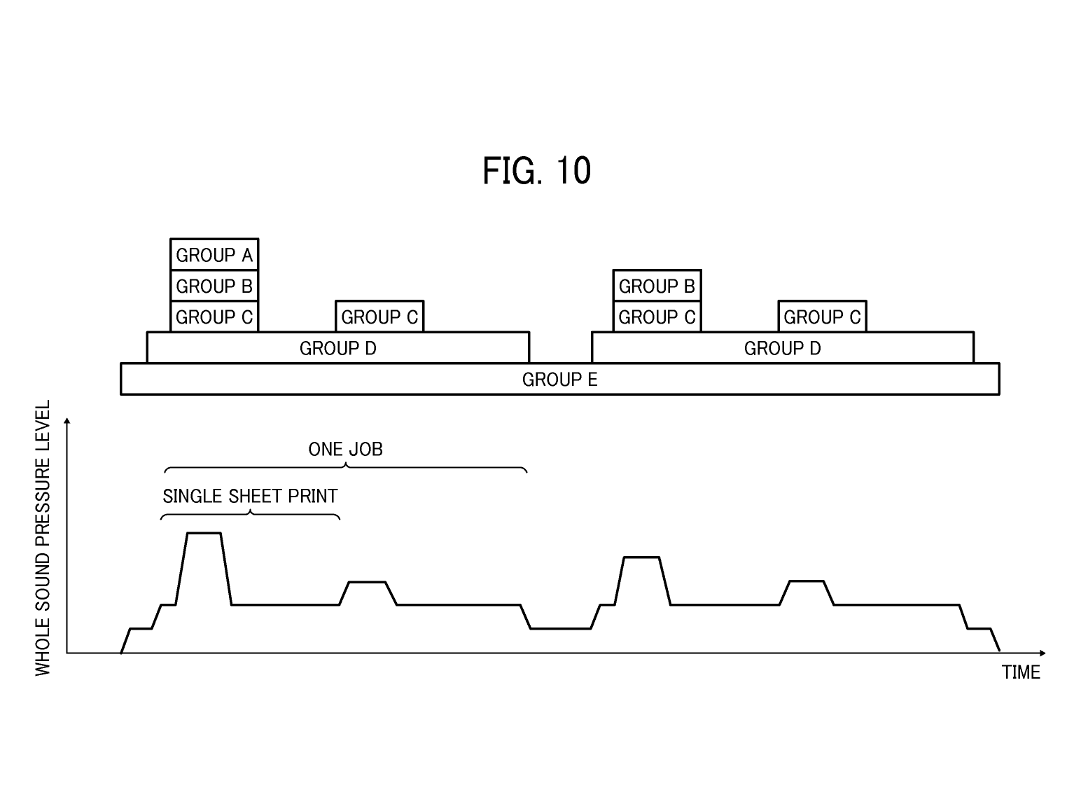

In addition, in general, as illustrated in FIG. 9, the breakdown rate of a part drastically rises for the number of prints, the number of jobs, the number of switch on/off of the image forming apparatus 1 when the life expectancy of the part expires.

The operation timing of a part changes depending on the number of prints, the number of jobs, the number of switch on/off of the image forming apparatus 1. Furthermore, the replacement timing of parts having the same life expectancy differs depending on the frequency of use of the image forming apparatus 1.

The part replacement timing calculation unit 47 calculates the part replacement timing for each user and each part according to the history of frequency of use. For this reason, it is possible to avoid discomfort and prevent wasteful replacement of a part still having a life expectancy, thereby to improve the use environment, avoid wasting parts, and reduce the cost.

When the part replacement timing calculation unit 47 determines the inaudible abnormal noise of a target part as a breakdown noise, it checks the number of occurrences in the past as described later and determines that part replacement is necessary by an emergency visit unless the number of occurrence is below the regulated number of times. In this case, since it is impossible to operate the part in trouble, the image forming apparatus 1 switches operation modes according to the part in trouble to avoid a downtime ascribable to part replacement.

The part replacement timing notification unit 48 outputs the replacement timing of the part calculated by the part replacement timing calculation unit 47 and the name of the part to the CPU 21 of the engine control unit 20 and the CPU 21 outputs it to the control unit 10.

The control unit 10 displays the replacement timing of the part and the name of the part on the display of the operation display unit 500 or the display of the information processing apparatus JS or executes notification processing to notify the service center of the image forming apparatus 1 connected with the network NW.

The operation noise timing control unit 40 acquires operation modes in which the abnormal noise stored in the known abnormal noise data memory 46 occurs and the timing information acquiring an operation noise from the abnormal noise occurrence condition and outputs it to the CPU of the engine control unit 20.

Based on the operation noise acquiring timing information from the operation noise timing control unit 40, the CPU 21 controls the operation of the operation noise acquiring unit 31a of the abnormal noise detection units 33a to 33e and the acquiring timing of the operation noise through the microphones Ma to Me.

Thereafter, the CPU 21 restricts the operations using the part causing the abnormal noise of the operations of the image forming apparatus 1 based on the part replacement timing, the abnormal noise occurrence operation mode, the abnormal noise occurrence conditions, etc. from the part replacement timing processing unit 34. Also, the CPU 21 allows normal prosecution for the operations free of the part causing the abnormal noise via the control unit 10. Therefore, the CPU 21 and the part replacement timing processing unit 34 serve as abnormal noise countermeasures as a whole by restricting the operations using the part causing the abnormal noise and allowing normal prosecution of the operations free of the part causing the abnormal noise.

In the operation control of the image forming apparatus 1 based on the operation noise, the control unit 10, the engine control unit 20, and the abnormal noise detection control unit 30 serve as an abnormal noise operation control unit (abnormal noise operation control device) 50 as a whole to improve utility of the image forming apparatus 1 while securing safety of the entire image forming apparatus 1 and reducing the level of discomfort caused by operation noises. Therefore, the image forming apparatus 1 carries the abnormal noise operation control unit 50 to conduct operation control based on abnormal noises. The abnormal noise operation control unit 50.

The image forming apparatus 1 is configured to execute an abnormal noise operation control method to improve utility of the apparatus by reading an abnormal noise operation control program that executes the abnormal noise operation control method of the present disclosure stored in a computer-readable recording medium such as ROM, Electrically Erasable and Programmable Read Only Memory (EEPROM), Erasable and Programmable Read Only Memory (EPROM), flash memory, flexible disk, Compact Disc Read Only Memory (CD-ROM), Compact Disc Rewritable (CD-RW), Digital Versatile Disk (DVD), Universal Serial Bus (USB) memory, Secure Digital (SD) card, and Magneto-Optical Disc (MO) and introducing it into the ROM 22, etc. of the engine control unit 20 while securing safety of the entire of the apparatus and reducing discomfort caused by operation noises in the operation control of the image forming apparatus 1 based on the operation noise described later. This abnormal noise operation control program is computer-executable and coded by a legacy programming language and an object-oriented programming language such as assembler, C, C++, C3, and Java™. The control program can be distributed by storing it on the recording medium mentioned above.

Operations of this embodiment is described below. The image forming apparatus 1 of this embodiment improves utility of the apparatus while securing safety of the entire of the apparatus and lowering the level of discomfort caused by the operation noise in the operation control of the image forming apparatus 1 based on the operation noise.

That is, the image forming apparatus 1 executes various operations using many parts. These many parts are rarely replaced simultaneously due to expiration of their life expectancies in the image forming apparatus 1. In addition, as the parts deteriorate, abnormal noises become louder during the operation of the parts.

The image forming apparatus 1 has multiple operation modes and what part is operated and what operation noise occurs depend on the operation mode. When this operation noise is inaudible, it is possible to execute operation control or replacement timing control of a part considering only the level of degradation of the part. When it is audible, it is suitable to execute operation control or replacement timing control of a part considering the level of discomfort of people around the image forming apparatus 1.

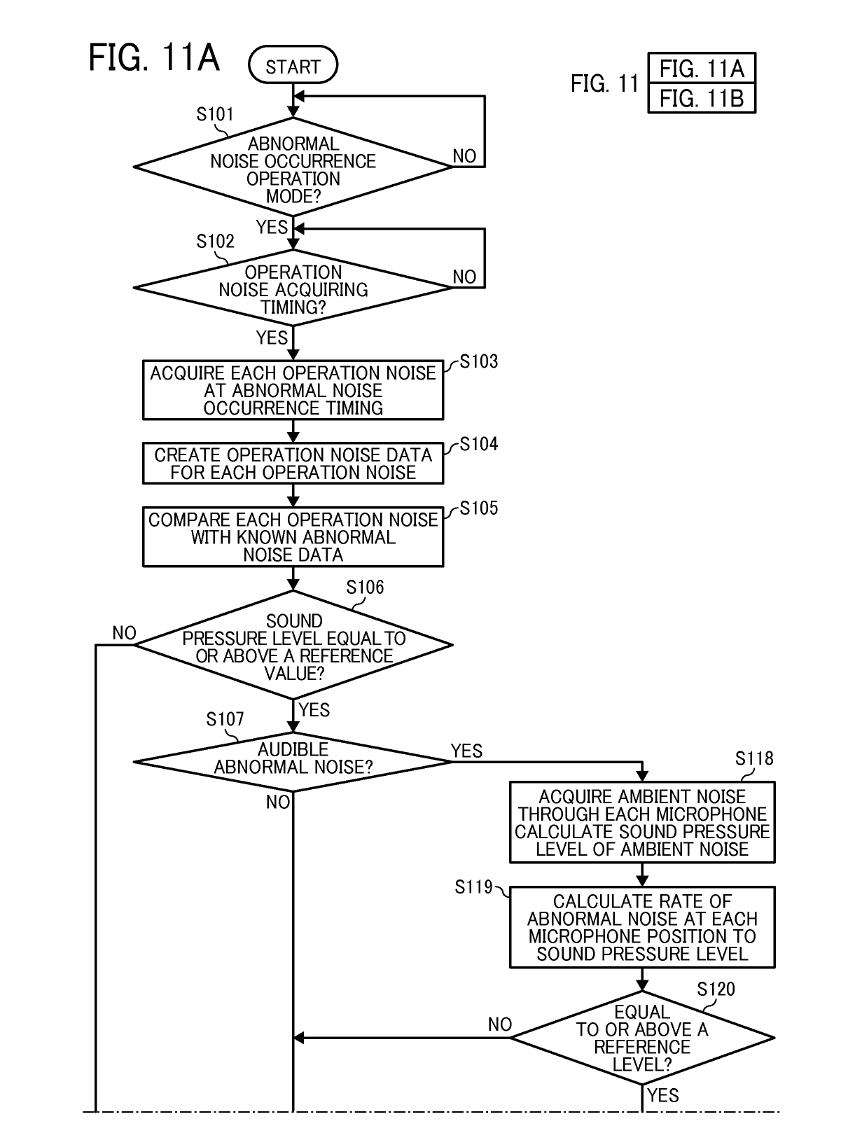

That is, for example, the operation timings of parts differ as illustrated in FIG. 10 and roughly classified into the part group A to the part group E. In FIG. 10, the part group E includes parts such as a cooling fan and constantly operates while the power supply is turned on. The part group D includes parts such as a fixing sleeve, a photoconductor, and a transfer belt and operates only when a print job is executed. The part group C includes parts such as a scanner motor and parts relating to sheet feeding from the sheet cassette 102 and sheet feeding from the bypass tray 204 which operate sporadically according to a print cycle or a scanning cycle. The part group B includes parts relating to the contact during intermediate transfer and the contact during secondary transfer which operate sporadically according to a unit of job. The part group A includes parts such as a toner bottle which operates only on a special occasion.

As illustrated in the lower part of FIG. 10, the parts of the part group E are driven in a single job and the part of the part group D are driven until the job completes. Thereafter, the parts of the part group C, the part group D, and the part group A are driven and after the drive of them is complete, the parts of the part group C are driven. After the drive of them is complete, the drive of the parts of the part group D is complete to finish the job. The sound pressure level of the operation noise inside changes according to the drive of the parts of these part groups as illustrated in the lower part of FIG. 10.

Thereafter, the known abnormal noise data memory 46 of the abnormal noise detection units 33a to 33e stores what part group is driven at what operation timing for each operation mode of various functions of the image forming apparatus 1 in advance.

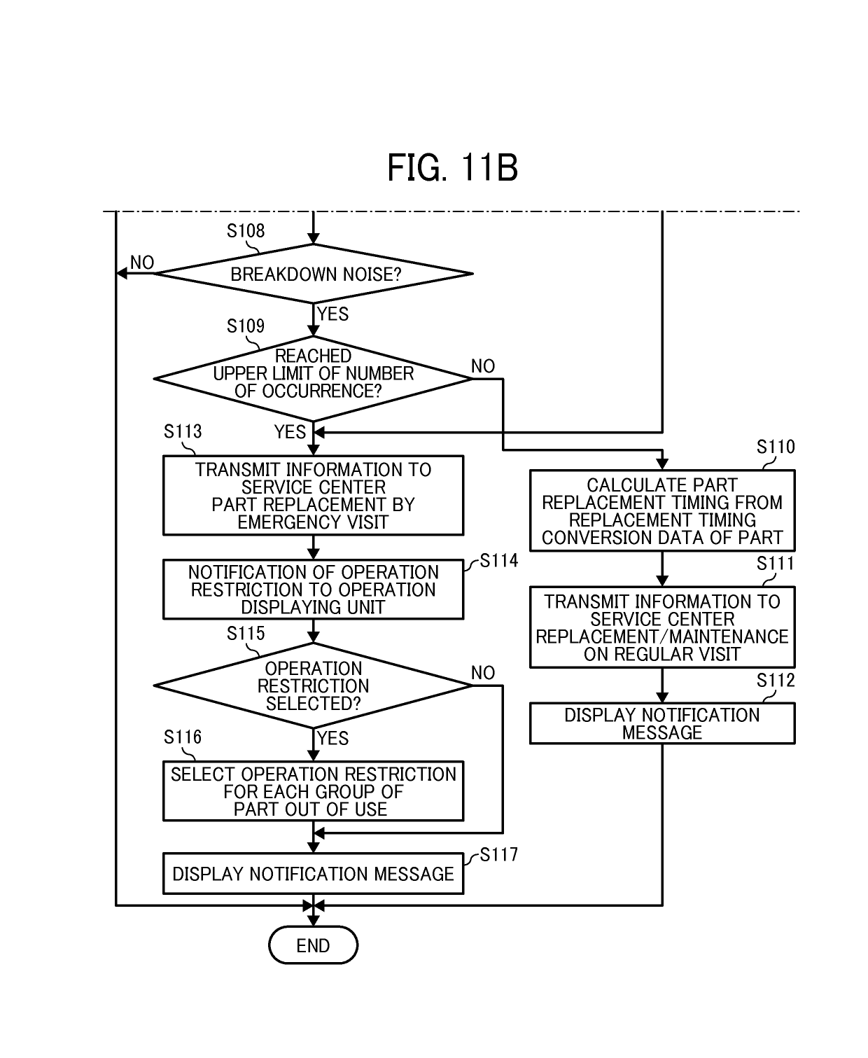

As illustrated in FIG. 11, the image forming apparatus 1 acquires the operation noise for each operation timing of each of the part groups A to E, detects whether there is an abnormal noise and loudness thereof, and determines whether the abnormal noise is audible or inaudible. The image forming apparatus 1 identifies a part causing the abnormal noise, determines the level of the abnormal noise according to whether the abnormal noise is audible or inaudible, and controls operations by restricting only the operation mode using the part causing the abnormal noise.

In the switching of the operation mode, the image forming apparatus 1 provides an operation restriction notification to the display of the operation display unit 500. When a user selects the operation restriction, the selected operation is still available. For example, the image forming apparatus 1 executes the following operation restrictions for each group having a part in trouble. That is, when the part in trouble belongs to the part group E, operation of the image forming apparatus 1 is stopped because the fan, etc. constantly operates while the power is on. When the color drum of the part group D is in trouble, the image forming apparatus 1 stops the drum and restricts to operations in the monochrome print mode. In addition, when the part in trouble belongs to the part group C and the scanner is out of order, scanning and photocopying are controlled to be not available but the printer unit is still operable. In addition, when the bypass sheet feeding is in trouble, only bypass sheet feeding is stopped, when the first sheet feeding is in trouble, only first sheet feeding is stopped, and when the second sheet feeding is in trouble, only second sheet feeding is stopped to control sheet feeding not including the part in trouble to be operable. Furthermore, when the part in trouble belongs to the part group B and the secondary transfer contact is abnormal, the image forming apparatus 1 conducts operation control to restrict operations in order not to execute the adjustment mode (process control, color matching control) while the second transfer is not in contact. Moreover, the image forming apparatus 1 conducts operation controls not to execute toner supply when a part in trouble belonging to the part group A drives the toner bottle abnormally.

In the following descriptions, “sheet transfer abnormal noise” is detected and the transfer motor is identified as the part causing the noise. However, the operation noise and the part are not limited thereto.

The CPU 21 stands by in an arbitrary operation mode until the operation mode is switched to the trouble occurrence operation mode based on the information from the operation noise acquiring timing control unit 40 (Step S101). The sheet transfer abnormal noise is emitted in print jobs of photocopying and printing as illustrated in FIG. 6. Furthermore, this noise is emitted only during a sheet printing (printing A3 size). The CPU 21 stands by at the Step S101 until the operation mode is changed to the print operation mode (operation mode for A3-size printing).

In the Step S101, in the case of A3 size printing, whether it is the operation noise acquiring timing (for example, for each 100 page for the number of A3 printing) set in advance is checked (Step S102).

In the Step S101, at the operation noise acquiring timing (Yes to the Step S101), the CPU 21 sequentially acquires the operation noises (operation noise corresponding to the abnormal noise No. 2 in FIG. 6) from the microphones Ma to Me while controlling the operation noise acquiring unit 31 (Step S103).

The abnormal noise detection unit 30 sequentially converts the analog operation noises of the operation noises (operation noise No. 2) acquired through the microphones Ma to Me into digital operation noise by the A/D conversion unit 41 and the data are stored in the operation noise memory 42 (Step S104). Since only the operation noise emitted during sheet transfer is acquired, the required capacity of the operation noise memory 42 can be reduced.

Next, the FFT analyzing unit 43 of the operation noise analyzing units 32a to 32e conducts Fourier conversion of the operation noise in the operation noise memory 42 of the operation noise acquiring units 31a to 31e to generate the sound pressure level for each frequency and the sound pressure level data for each frequency are stored in the operation noise data memory 44.

Thereafter, when new operation noise data are stored, the abnormal noise detection units 33a to 33e check whether each operation noise in the operation noise data memory 44 has a sign leading to an abnormal noise (Step S105 and Step S106). Specifically, the breakdown noise/discomfort noise determining unit 45 of the abnormal noise detection units 33a to 33e compares the sound pressure level data of the operation noise for each frequency stored in the operation noise data memory 44 with the known abnormal noise data in the known abnormal noise data memory 46 (Step S105). Thereafter, the breakdown noise/discomfort noise determining unit 45 determines whether the sound pressure level data of the operation noise has reached or surpassed the known abnormal noise data (reference value) (Step S106) and when not reached (No in Step S106), the operation noise is determined as having no sign leading to an abnormal noise and the operation is back to normal.

If the sound pressure level data has reached or surpassed the known abnormal noise data (Yes in Step S106), the breakdown noise/discomfort noise determining unit 45 determines it as the operation noise having a sign leading to an abnormal noise and determines whether the operation noise is audible or inaudible (Step S107). Whether the abnormal noise is audible or inaudible is determined based on, for example, whether it is in the range of from about 20 Hz to about 15,000 Hz, which audible to the human ear, as described above.

When the abnormal noise is audible, users feel it as uncomfortable. When the abnormal noise is inaudible, users do not perceive it so that the part can still be used unless it leads to immediate breakdown.

When the abnormal noise is in the inaudible range (No in Step S107), the breakdown noise/discomfort noise determining unit 45 determines whether or not the abnormal noise is a breakdown noise (Step S108).

When the noise is not caused by a breakdown (No in the Step S108), the breakdown noise/discomfort noise determining unit 45 terminates the abnormal noise operation control processing since the noise is inaudible and not perceived as discomfort to a user.

When the noise is a breakdown noise (Yes in the Step S108), whether the number of occurrence of abnormal noises has reached the limit of the preset regulated number of occurrence is checked (Step S109). This limit of the preset regulated number of occurrence is set in advance based on the replacement timing of the part, etc.

When the number of occurrence is less than the preset regulated number of occurrence (No in Step S109), the breakdown noise/discomfort noise determining unit 45 notifies the part replacement timing processing units 34a to 34e of the frequency and the sound pressure level of the abnormal noise.

The part replacement timing calculating unit 47 of the part replacement timing processing units 34a to 34e refers to the part replacement timing conversion data memory 49 based on the frequency and the sound pressure level of the abnormal noise and calculates the part replacement timing (Step S110). As described above, the part replacement timing calculating unit 47 calculates the replacement timing of the part for the frequency in the articles of the abnormal noise by referring to the sound pressure level (reference level) set as illustrated in FIG. 7 to determine the part group to which the part belongs.

The part replacement timing notification unit 48 notifies CPU 21 of the engine control unit 20 of the replacement timing of the part calculated by the part replacement timing calculation unit 47. As described above, the CPU 21 notifies the service center of the image forming apparatus 1 of part replacement or maintenance on a regular visit (Step S111).

In addition, the CPU 21 provides the notification by displaying it on the operation display unit 500 or send the notification to the information processing apparatus JS (Step S112).

The CPU 21 conducts operation control to restrict operations using the part requiring replacement and allow operations that do not use the part among the operations of the image forming apparatus 1 based on the part replacement timing and the information in the part groups A to E.

The CPU 21 executes the notification processing and operation control processing and thereafter completes the abnormal noise operation control processing.

In the Step S109, when the number of occurrence has reached or surpassed the limit (Yes in the Step S109), the part replacement timing calculation unit 47 transfers information to make the part replacement timing notification unit 48 ask the service center to make an immediate visit to the user to replace the part (Step S113).

In addition, the part replacement timing notification unit 48 provides the notification of operation restriction to the user by displaying it on the operation display unit 500 or transmitting it to the information processing apparatus JS, etc. (Step S114).

In this case, the user who has received the notification of restriction operation selects the operation restriction or stop of the image forming apparatus 1.

The CPU 21 checks whether the operation restriction is selected (Step S115).

In the Step S115, when the operation restriction is selected (Yes in Step S115), the CPU 21 selects operation restriction for each group (part groups A to E) of the part causing trouble and executes processing (Step S116).

In the Step S116, when the restriction operation is selected for the group including the part causing trouble, the CPU 21 sends a message that the operations of the image forming apparatus 1 are restricted and completes the abnormal noise operation control processing (Step S117).

In the Step S115, when the restriction operation is not selected, the CPU 21 executes an operation to stop the image forming apparatus 1 and also sends a message accordingly to complete the abnormal noise operation control processing (Step S117).

Furthermore, when the abnormal noise is an operation noise in the audible range (Yes in Step S107), the CPU 21 makes each of the microphones Ma to Me collect the ambient noise around the image forming apparatus 1 and makes the operation noise analyzing unit 32a to 32e calculate the sound pressure level (Step S118).

Next, the CPU 21 makes the breakdown noise/discomfort noise determining unit 45 calculate the rate of the sound pressure level of the abnormal noise at each of the positions of the microphones Ma to Me to the sound pressure level of the ambient noise (Step S119). The CPU 21 makes the breakdown noise/discomfort noise determining unit 45 check whether the rate of the abnormal noise to the ambient noise is not less than the preset regulation value (Step S120). This regulation value is suitably set based on the installation environment of the image forming apparatus 1 and comfort level demanded to the abnormal noise and, for example, stored in the known abnormal noise data memory 46.

When the rate of the abnormal noise to the ambient noise is less than the regulation value (No in the step S120), the abnormal noise detection control units 30a to 30e determine the abnormal noise as non-discomfort noise and the processing is back to 108. The abnormal noise detection control units 30a to 30e execute the same processing as described above according to the processing to check whether the noise is abnormal (Steps S108 to S120).

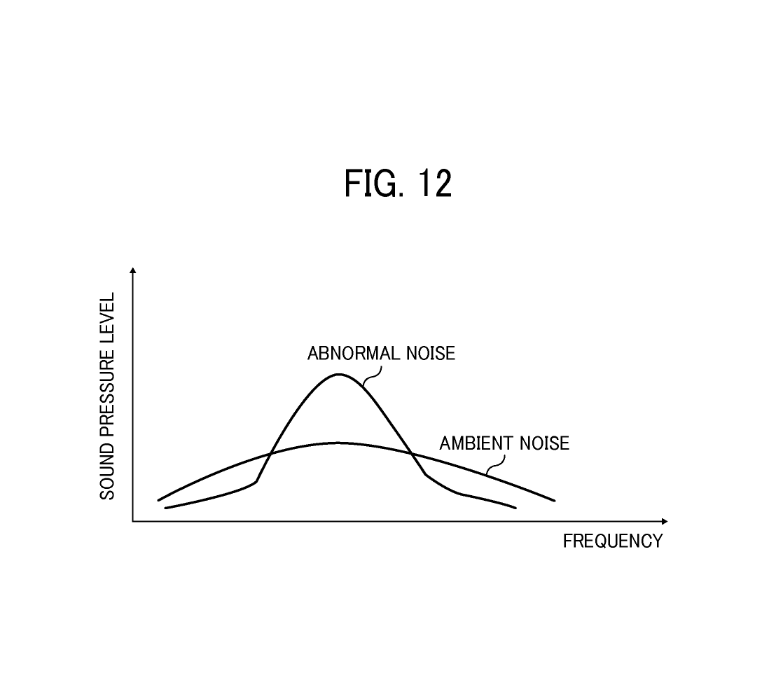

As illustrated in FIG. 12, users perceive the abnormal noise as discomfort noise or non-discomfort noise depending on the relation with the ambient noise. For example, when the sound pressure of an ambient noise is high, the abnormal noise in the image forming apparatus 1 is not easily perceived as a discomfort noise. Therefore, the image forming apparatus 1 calculates the rate of the sound pressure level of each abnormal noise to the sound pressure level of the ambient noise detected at each position of the microphones Ma to Me. Whether a noise causes discomfort is determined based on this rate.

When the rate of the abnormal noise to the ambient noise is not less than the regulation value (Yes in the step S120), the abnormal noise detection control units 30a to 30e determine the abnormal noise as a discomfort noise. When the abnormal noise control units 30a to 30e determine the noise as a discomfort noise, the part replacement timing notification unit 48 sends a message to ask the service center to replace the part on emergency visit (Step S113) and notifies a user of operation restriction (Step S114). The CPU 21 checks whether the operation restriction is selected (Step S115). In the Step S115, when the operation restriction is selected (Yes in Step S115), the CPU 21 selects operation restriction for each group (part groups A to E) of the part causing trouble and executes processing (Step S116). In the Step S116, when the restriction operation is selected for the group including the part causing trouble, the CPU 21 sends a message that the operations of the image forming apparatus 1 are restricted and completes the abnormal noise operation control processing (Step S117). In the Step S115, when the restriction operation is not selected, the CPU 21 stops the image forming apparatus 1 and sends a message accordingly to complete the abnormal noise operation control processing (Step S117).

As described above, the image forming apparatus 1 includes the abnormal noise operation control unit (abnormal noise operation control device) 50 including a known abnormal noise data memory (abnormal noise storage device) 46 to store the abnormal noise when a trouble occurs to the image forming apparatus (apparatus) 1 in advance, microphones (operation noise acquisition device) Ma to Md to acquire the operation noise of the image forming apparatus 1, an operation noise analyzing unit (audible sound determination device) to determine whether or not the acquired operation noise is audible, abnormal noise detection units (discomfort noise determination device) 33a to 33e to determine whether or not the audible sound is a discomfort noise, abnormal noise detection units (fault determination device) 33a to 33e to determine whether or not the operation noise is abnormal by comparing the operation noise with the acquired abnormal noise, abnormal noise detection units (abnormal noise cause determination device) 33a to 33e to identify a part causing the operation noise determined as at least one of the discomfort noise or the abnormal noise, a CPU (abnormal noise countermeasures device) 21 to restrict operations that use the part and allow operations that do not use the part, and a part replacement timing processing unit 34.

Therefore, whether the operation noise is a discomfort noise or an abnormal noise is determined and if it is one of these, it is possible to stop the operations that use the part causing the discomfort noise or the abnormal noise and allow the other operations normally. As a result, in the operation control of the image forming apparatus 1 based on the operation noises thereof, it is possible to improve utility of the image forming apparatus 1 while securing safety of the entire of the apparatus and reducing the level of discomfort caused by the operation noise.

In the image forming apparatus 1 of the embodiment, the abnormal noise control unit 50 executes the method including an operation noise acquisition processing step of acquiring an operation noise of the image forming apparatus 1, an audible noise determination processing step of determining whether or not the operation noise is an audible sound, a discomfort noise determination processing step of determining whether or not the audible sound is a discomfort noise, a fault determination processing step of determining whether or not the operation noise is abnormal by comparing the acquired operation noise with the abnormal noise of the image forming apparatus 1 in trouble stored in the known abnormal noise data memory (abnormal noise storage device) 46 in advance, an abnormal noise cause determination processing step of identifying a part causing the operation noise determined as at least one of the discomfort noise or the abnormal noise, and an abnormal noise countermeasures step of restricting operations that use the part while allowing operations that do not use the part.

Therefore, whether the operation noise is a discomfort noise or an abnormal noise is determined and if it is one of these, it is possible to stop the operations that use the part causing the discomfort noise or the abnormal noise and allow the other operations normally. As a result, in the operation control of the image forming apparatus 1 based on the operation noises thereof, it is possible to improve utility of the image forming apparatus 1 while securing safety of the entire of the apparatus and reducing the level of discomfort caused by the operation noise.

Furthermore, in the image forming apparatus 1 of the embodiment, the abnormal noise control unit 50 includes a control processor such as the CPU 21 containing an abnormal noise operation control program to execute an operation noise acquisition processing of acquiring an operation noise of the image forming apparatus 1, an audible noise determination processing of determining whether or not the operation noise is an audible sound, a discomfort noise determination processing of determining whether or not the audible sound is a discomfort noise, a fault determination processing of determining whether or not the operation noise is abnormal by comparing the acquired operation noise with the abnormal noise of the image forming apparatus 1 in trouble stored in the known abnormal noise data memory (abnormal noise storage device) 46 in advance, an abnormal noise cause determination processing of identifying a part causing the operation noise determined as at least one of the discomfort noise or the abnormal noise, and an abnormal noise countermeasure of restricting operations that use the part while allowing operations that do not use the part.

Therefore, whether the operation noise is a discomfort noise or an abnormal noise is determined and if it is one of these, it is possible to stop the operations using the part causing the discomfort noise or the abnormal noise and allow the other operations normally. As a result, in the operation control of the image forming apparatus 1 based on the operation noises thereof, it is possible to improve utility of the image forming apparatus 1 while securing safety of the entire of the apparatus and reducing the level of discomfort caused by the operation noise.

In addition, in the image forming apparatus 1 of this embodiment, the abnormal noise detection units (discomfort noise determination device) 33a to 33e of the abnormal noise operation control unit 50 determine whether or not the audible sound is uncomfortable based on loudness of the audible sound.

Therefore, it is possible to easily and suitably determine whether or not the audible operation noise of the image forming apparatus 1 causes discomfort. As a result, in the operation control of the image forming apparatus 1 based on the operation noises thereof, it is possible to improve utility of the image forming apparatus 1 while securing safety of the entire of the apparatus and suitably reducing the level of discomfort caused by the operation noise furthermore.

In addition, in the image forming apparatus 1 of this embodiment, the abnormal noise operation control unit 50 further includes the microphones (ambient noise acquisition device) Ma to Me to acquire the ambient noise around the image forming apparatus 1 and the abnormal noise detection units (discomfort noise determination device) 33a to 33e determine whether or not the audible sound causes discomfort based on loudness of the audible sound and the ambient noise.

Therefore, it is possible to more easily and more suitably determine whether or not the audible operation noise of the image forming apparatus 1 causes discomfort. As a result, in the operation control of the image forming apparatus 1 based on the operation noises thereof, it is possible to improve utility of the image forming apparatus 1 while securing safety of the entire of the apparatus and suitably reducing the level of discomfort caused by the operation noise furthermore.

In the image forming apparatus 1 of the embodiment, the abnormal noise operation control unit 50 further includes the part replacement timing processing unit (remaining life expectancy prediction device) 34 to predict life expectancy of the part causing at least one of the discomfort noise or the abnormal noise based on loudness of the operation noise determined as at least one of the discomfort noise and the abnormal noise, and the CPU 21 serving as the abnormal noise countermeasures device and the part replacement timing processing unit 34 control the operations that use the part causing the abnormal noise according to the life expectancy and provide a notification of the life expectancy of the part causing the abnormal noise predicted by the part replacement timing processing unit 34 and a request to repair the part.

Therefore, based on the remaining life expectancy of the part causing at least one of the discomfort noise and the abnormal noise, operation control can be made and measures to deal with the trouble (fault) can be taken by providing required notifications. As a result, in the operation control of the image forming apparatus 1 based on the operation noises thereof, it is possible to improve utility of the image forming apparatus 1 while suitably securing safety of the entire of the apparatus furthermore and suitably reducing the level of discomfort caused by the operation noise furthermore.

Moreover, the image forming apparatus 1 of the embodiment includes multiple operation modes using different operable parts and the abnormal noise operation control unit 50 in the image forming apparatus 1 controls changing to the operation mode relating to the part causing the abnormal noise by the CPU 21 serving as the abnormal noise countermeasure device and a the part replacement timing processing unit 34.

Therefore, it is possible to control the operation of the image forming apparatus 1 for each operation mode provided to the image forming apparatus 1 and improve utility of the image forming apparatus 1 while securing safety of the entire of the apparatus and suitably reducing the level of discomfort caused by the operation noise furthermore.

In addition, the image forming apparatus 1 of the embodiment has multiple operation modes using different operable parts, and microphones (operation noise acquisition device) Ma to Me of the abnormal noise operation control unit 50 of the image forming apparatus 1 acquires the operation noise for each of the multiple operation modes.

Therefore, it is possible to acquire suitable operation noise while selecting the operation noises to be acquired to control operations. As a result, it is possible to improve utility of the image forming apparatus 1 while easily and inexpensively securing safety of the entire of the apparatus and suitably reducing the level of discomfort caused by the operation noise.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

According to the present disclosure, an operation control based on operation noises of an apparatus is provided to reduce the level of discomfort caused by the operation noise and improve utility of the device while securing safety of the entire of the apparatus.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An abnormal noise operation control device, comprising:
an abnormal noise storage device to store an abnormal noise at a time of a fault of an apparatus in advance;
an operation noise acquisition device to acquire an operation noise of the apparatus;
an audible sound determination device to determine whether or not the operation noise acquired is audible sound;
a discomfort noise determination device to determine whether or not the audible sound is a discomfort noise;
a fault determination device to determine whether or not the operation noise is abnormal by comparing the operation noise with the abnormal noise;
an abnormal noise cause determination device to identify a part causing the operation noise determined as at least one of the discomfort noise or the abnormal noise; and
an abnormal noise countermeasures device to restrict operations that use the part and allow operations that do not use the part.

2. The abnormal noise operation control device according to claim 1, wherein the discomfort noise determination device determines whether or not the audible sound is a discomfort noise based on loudness of the audible sound.

3. The abnormal noise operation control device according to claim 1, further comprising an ambient noise acquisition device to acquire an ambient noise around the apparatus, wherein the discomfort noise determination device determines whether or not the audible sound is a discomfort noise based on loudness of the audible sound and loudness of the ambient noise.

4. The abnormal noise operation control device according to claim 1, further comprising a remaining life expectancy prediction device to predict life expectancy of the part causing at least one of the discomfort noise or the abnormal noise based on loudness of the operation noise determined as at least one of the discomfort noise or the abnormal noise, wherein the abnormal noise countermeasures device controls the operations using the part according to the life expectancy and provides a notification of the life expectancy of the part predicted by the remaining life expectancy prediction device and a request to repair the part.

5. The abnormal noise operation control device according to claim 1, wherein the apparatus has multiple operation modes using different operable parts, and the abnormal noise countermeasures device controls shifting to a mode relating to the part causing the abnormal noise in the multiple operation modes.

6. The abnormal noise operation control device according to claim 1, wherein the apparatus has multiple operation modes using different operable parts, and the operation noise acquisition device acquires the operation noise for each of the multiple operation modes.

7. An image forming apparatus, which transfers a recording medium and executes image forming processing using the recording medium, comprising:
the abnormal noise control device of claim 1 to control operations by detecting an operation noise made during the image forming processing.

8. An abnormal noise operation control method, comprising:
acquiring an operation noise of an apparatus;
determining whether or not the operation noise acquired is an audible sound;
determining whether or not the audible sound is a discomfort noise;
determining whether or not the operation noise is abnormal by comparing the operation noise with the abnormal noise of the apparatus stored in an abnormal noise storage device in advance;
identifying a part causing the operation noise determined as at least one of the discomfort noise or the abnormal noise; and
restricting operations using the part while allowing operations that do not use the part.

9. A non-transitory recording medium which, when executed by one or more processors, perform an abnormal noise operation control method, comprising:
acquiring an operation noise of apparatus;
determining whether or not the operation noise acquired is an audible sound;
determining whether or not the audible sound is a discomfort noise;
determining whether or not the operation noise is abnormal by comparing the operation noise with the abnormal noise of the apparatus stored in an abnormal noise storage device in advance;
identifying a part causing the operation noise determined as at least one of the discomfort noise or the abnormal noise; and
restricting operations using the part while allowing operations that do not use the part.
